(19) United States
(12) Patent Application Publication
(10) Pub. No.: US 2022/0236899 A1
(43) Pub. Date: Jul. 28, 2022

(54) INFORMATION PROCESSING APPARATUS, INFORMATION PROCESSING METHOD, AND COMPUTER-READABLE RECORDING MEDIUM STORING INFORMATION PROCESSING PROGRAM

(71) Applicant: FUJITSU LIMITED, Kawasaki-shi (JP)

(72) Inventors: Shinya Toyonaga, Kawasaki (JP); Ryuichi MATSUKURA, Kawasaki (JP)

(73) Assignee: FUJITSU LIMITED, Kawasaki-shi (JP)

(21) Appl. No.: 17/509,102

(22) Filed: Oct. 25, 2021

(30) Foreign Application Priority Data
Jan. 25, 2021 (JP) 2021-009780

(51) Int. Cl. G06F 3/06; G06N 3/08; G06N 5/04

(52) U.S. Cl. CPC G06F 3/0631; G06N 3/08; G06F 3/0679; G06F 3/0604; G06N 5/04

(57) ABSTRACT

An information processing apparatus includes: a learning arithmetic processing circuit configured to perform each of a plurality of inference processes based on deep learning by using a memory area allocated to the inference process; and a processor configured to perform processing, the processing including: predicting an in-use memory area of each of the inference processes, based on a profile denoting a change in a memory usage while the inference process is performed by the learning arithmetic processing circuit according to an algorithm of the inference process and based on a start history of the inference process, and creating a memory map, based on the predicted in-use memory area; and allocating the memory area to the inference process, based on the memory map to cause the learning arithmetic processing circuit to perform each of the inference processes.

### CROSS-REFERENCE TO RELATED APPLICATION

This application is based upon and claims the benefit of priority of the prior Japanese Patent Application No. 2021-9780, filed on Jan. 25, 2021, the entire contents of which are incorporated herein by reference.

### FIELD

The embodiments discussed herein are related to an information processing apparatus, an information processing method, and a computer-readable recording medium storing an information processing program.

### BACKGROUND

In recent years, the society and the consumption behavior of people have been rapidly changing. Companies are desired to deal with such changes. In the course of dealing with such changes, digital transformation (DX) which is a reform of an organization or a business model by digitalization is attracting attention.

In DX, it is important to find a value from data generated on-site. For example, in a traffic monitoring system, a video from a camera installed at an intersection is made use of in traffic-based city planning, license-number-based anti-crime measures, and the like.

In DX, low latency and high security performance are desired as requests for applications. For this reason, the number of use cases where data processing is to be performed in the vicinity of a data generation source is increasing. The vicinity of the data generation source may be called an edge in some cases. To perform data processing in the vicinity of the data generation source, a server or the like installed at the edge is utilized.

An amount of data to be generated also increases due to an increase in the number of various devices that generate data on-site such as an increase in the number of installed cameras and sensors. If the amount of data increases, an existing server deployed at the edge is desired to efficiently perform a plurality of data processes.

In video analysis, deep learning (deep neural network (DNN)) is often used. The use of a graphics processing unit (GPU) enables high-speed processing. A video inference process based on deep learning is used for detecting an object from an input image and determining a class to which the object belongs. A class is a set having specific characteristics, such as people, automobiles, dogs, and cats.

In deep learning, an operation for extracting a feature quantity from an input is expressed as a layer. A plurality of layers are coupled to each other in multiple stages. In this manner, learning and inference are performed. In video analysis using deep learning, a probability of an object belonging to each class is output based on the feature quantity extracted in each layer.

In a case of deep learning for video analysis, the size of the feature quantity peaks in an initial layer and gradually decreases as the data passes through the layers. Since each layer performs processing by using an output of the immediately preceding layer, an amount of GPU memory to be used also decreases with the elapse of time in a phase in which the size of the feature quantity decreases.

In the related art, to increase the GPU utilization efficiency, a technique has been proposed that enables parallel execution of a plurality of deep learning processes on a GPU. For example, there is a technique for enabling, by dividing a memory amount based on peaks of GPU memory usages of respective processes, deep learning to be performed in parallel in a range in which the sum of the peaks for the respective processes is less than or equal to a GPU memory size.

There is also a technique for extracting a matrix operation that is common to machine learning, collectively assigning a plurality of arithmetic processes to a single GPU kernel to optimize processing, executing a plurality of GPU kernels in parallel, and integrating the respective intermediate outputs to obtain an operation result. There is also a technique in which a scheduler selects an inference model and an image analysis service to be allocated to each application, allocates the selected inference model and image analysis service to a physical machine, monitors latency and the like, and learns an appropriate combination. There is also a technique for obtaining a plurality of outputs by deploying, in a memory, some of inputs of a convolutional operation, used for calculating some of outputs, sequentially overwriting the inputs that have become unnecessary with the next inputs, and applying a plurality of kernels to the inputs in parallel.

Examples of the related art include as follows: U.S. Patent Application Publication No. 2017/0032487; U.S. Patent Application Publication No. 2020/0193218; and U.S. Patent Application Publication No. 2018/0189643.

### SUMMARY

According to an aspect of the embodiments, an information processing apparatus includes: a learning arithmetic processing circuit configured to perform each of a plurality of inference processes based on deep learning by using a memory area allocated to the inference process; and a processor configured to perform processing, the processing including: predicting an in-use memory area of each of the inference processes, based on a profile denoting a change in a memory usage while the inference process is performed by the learning arithmetic processing circuit according to an algorithm of the inference process and based on a start history of the inference process, and creating a memory map, based on the predicted in-use memory area; and allocating the memory area to the inference process, based on the memory map to cause the learning arithmetic processing circuit to perform each of the inference processes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a server;

FIG. 2 describes calculation of an in-use GPU memory area;

FIG. 3 illustrates an example of a memory map indicating a GPU memory area allocatable to another process;

FIG. 4 illustrates an example of a change in a GPU memory usage of each layer;

FIG. 5 illustrates an example of a modeled GPU memory usage;

FIG. 6 describes profiling of the change in the GPU memory usage;

FIG. 7 illustrates an example of a profile denoting the change in the GPU memory usage;

FIG. 8 is a flowchart of memory allocation control for a deep learning process according to a first embodiment;

FIG. 9 is a sequence diagram of the memory allocation control for a deep learning process according to the first embodiment;

FIG. 10 illustrates a comparison between a memory usage in a case where GPU memory area division is performed according to peaks and a memory usage in a case where memory allocation according to the first embodiment is performed;

FIG. 11 describes parallelization of applications by using the change in the modeled GPU memory usage; and

FIG. 12 is a hardware configuration diagram of the server.

### DESCRIPTION OF EMBODIMENTS

However, in the related-art technique in which a memory area is divided based on the GPU memory usages, parallel processing is performed based on the peaks. Thus, the effect of parallelization of inference processes based on deep learning is limited. In the technique for executing the plurality of GPU kernels in parallel and integrating the intermediate outputs to obtain an operation result, parallel execution of a plurality of processes on a single GPU is not taken into consideration. The technique in which a scheduler learns an appropriate combination of an inference model and an image analysis service to be allocated to each application may meet the requests for the application. However, it is difficult to apply this technique to a technique for executing a plurality of processes in parallel on a single GPU. The technique for obtaining a plurality of outputs by applying a plurality of kernels to inputs in parallel in a convolution operation enables parallel execution of the convolution operation in a single machine learning process. However, it is difficult to apply this technique to a technique for executing a plurality of processes in parallel on a single GPU. Therefore, with any of the techniques, it is difficult to improve the use efficiency of the GPU memory area and improve the processing efficiency of the inference processes based on deep learning.

A disclosed technique is conceived in view of the above, and an object thereof is to provide an information processing apparatus, an information processing method, and a computer-readable recording medium storing an information processing program that improve the processing efficiency of inference processes based on deep learning.

Embodiments of an information processing apparatus, an information processing method, and an information processing program disclosed in this application will be described in detail below based on the drawings. The information processing apparatus, the information processing method, and the information processing program disclosed in this application are not limited by the embodiments below.

### First Embodiment

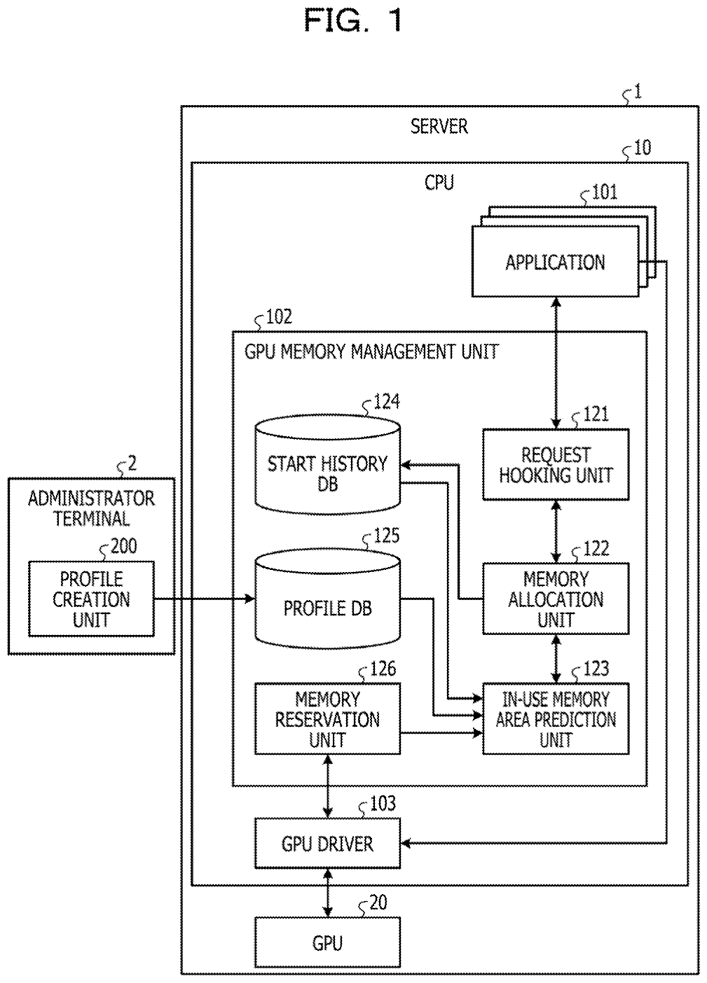

FIG. 1 is a block diagram of a server. A server 1 is, for example, an information processing apparatus installed at an edge and performs deep-learning-based video analysis by using a GPU 20. The server 1 is coupled to an administrator terminal 2. The server 1 includes a central processing unit (CPU) 10 and the GPU 20.

The CPU 10 includes a GPU memory management unit 102. The CPU 10 causes a plurality of applications 101 and a GPU driver 103 to operate.

The applications 101 each perform various processes such as video analysis using deep learning. For example, the applications 101 perform video analysis using deep learning, by using a framework such as TensorFlow. The applications 101 each cause the GPU 20 to perform an inference process based on deep learning during execution of various processes such as video analysis.

For example, the application 101 requests the GPU driver 103 to reserve a GPU memory area by using, for example, a Compute Unified Device Architecture (CUDA) (registered trademark) application programming interface (API). However, as described later, this GPU-memory-area reservation request is captured and processed by the GPU memory management unit 102. The application 101 receives a notification of information on an allocated GPU memory area from the GPU memory management unit 102. The application 101 instructs the GPU driver 103 to cause the GPU 20 to perform an inference process based on deep learning by using the allocated GPU memory area.

In the present embodiment, the configuration has been described in which the application 101 controls the GPU driver 103 so that the GPU driver 103 causes the GPU 20 to perform an inference process based on deep learning. However, the method for controlling the GPU driver 103 is not limited to this. For example, the application 101 may request a scheduler to perform control, and the scheduler may control the GPU driver 103.

The GPU memory management unit 102 allocates a GPU memory to be used by the GPU 20, to each of the applications 101 when the application 101 causes the GPU 20 to perform an inference process based on deep learning. The GPU memory management unit 102 includes a request hooking unit 121, a memory allocation unit 122, an in-use memory area prediction unit 123, a start history database (DB) 124, a profile DB 125, and a memory reservation unit 126.

The request hooking unit 121 takes, into the GPU memory management unit 102, a request from the application 101 toward the GPU driver 103. The function of the request hooking unit 121 enables the GPU memory management unit 102 to perform memory management without changing the application 101. However, the memory management method may be another method. As a method for acquiring a request from the application 101, a new API for memory management may be created in the GPU memory management unit 102 and the application 101 may call this API. In the present embodiment, the application 101 makes various requests by using the CUDA API. Thus, the request hooking unit 121 captures the CUDA API and takes the requests into the GPU memory management unit 102. Processing of capturing the CUDA API may be expressed as “hooking” in some cases.

For example, the request hooking unit 121 hooks and acquires a GPU-memory-area reservation request output from the application 101 toward the GPU driver 103. The request hooking unit 121 outputs the acquired GPU-memory-area reservation request to the memory allocation unit 122. The request hooking unit 121 acquires, as a response to the GPU-memory-area reservation request, information on an allocated GPU memory area from the memory allocation unit 122. The request hooking unit 121 outputs the information on the allocated GPU memory area to the application 101 that is a source of the request.

When the application 101 is newly started, the memory allocation unit 122 receives a GPU-memory-area reservation request from the request hooking unit 121. The memory allocation unit 122 outputs a memory map update request to the in-use memory area prediction unit 123. In this manner, the memory allocation unit 122 requests updating of the memory map. The memory allocation unit 122 acquires the memory map updated by the in-use memory area prediction unit 123. The updated memory map stores information indicating a GPU memory area that is a free area available at that time.

Based on the updated memory map and a requested GPU memory size, the memory allocation unit 122 then searches for an area to be allocated to the application 101 that has requested reservation of the GPU memory area. The memory allocation unit 122 determines a base address and a size of a GPU memory area to be allocated to the application 101 that has requested reservation of the GPU memory area. The memory allocation unit 122 notifies the request hooking unit 121 of the determined base address and size. The memory allocation unit 122 acquires a process identifier (ID) of the application 101 that has requested reservation of the GPU memory area, and acquires a name of the application 101 corresponding to the process ID. For example, in a case of Linux (registered trademark), it is possible to acquire a correspondence relationship between a process ID and an executed command by using a ps command. The memory allocation unit 122 registers, as a start history, the base address and the size of the GPU memory area allocated to the application 101 to the start history DB 124 along with a start time of the application 101 in association with the name of the application 101.

The start history DB 124 is a storage unit that stores a start history of each of the applications 101. In the start history DB 124, the base address and the size of the GPU memory area allocated to the application 101 and the start time of the application 101 are registered in association with the name of the application 101 by the memory allocation unit 122.

The profile DB 125 is a storage unit that stores a profile denoting a change in a GPU memory usage of each of the applications 101 with the elapse of time. In the profile DB 125, a profile previously created for each of the applications 101 by a profile creation unit 200 of the administrator terminal 2 in response to an instruction from an administrator is registered in advance. Creation of a profile will be described in detail later.

The in-use memory area prediction unit 123 acquires information on a base address and a size of the entire GPU memory available to the GPU 20 from the memory reservation unit 126. Consequently, the in-use memory area prediction unit 123 may grasp the available GPU memory area as the hardware constraint of the GPU 20.

When the application 101 is newly started, the in-use memory area prediction unit 123 performs a process below. The in-use memory area prediction unit 123 acquires, from the start history DB 124, start histories each including the start time of the started application 101 and the base address and the size of the GPU memory area allocated to the application 101. The started applications 101 do not include the newly started application 101. The in-use memory area prediction unit 123 acquires the profiles for the respective started applications 101 from the profile DB 125.

By using the start histories and the profiles, the in-use memory area prediction unit 123 predicts the GPU memory areas currently in use by the respective started applications 101. The started applications 101 do not include the newly started application 101. For example, the in-use memory area prediction unit 123 predicts a current GPU memory usage of each of the applications 101 from the profile and the elapsed time for the started application 101. The in-use memory area prediction unit 123 calculates an in-use GPU memory area from the base address and the GPU memory usage. For example, the in-use memory area prediction unit 123 determines the in-use GPU memory area by adding the base address and the GPU memory usage together.

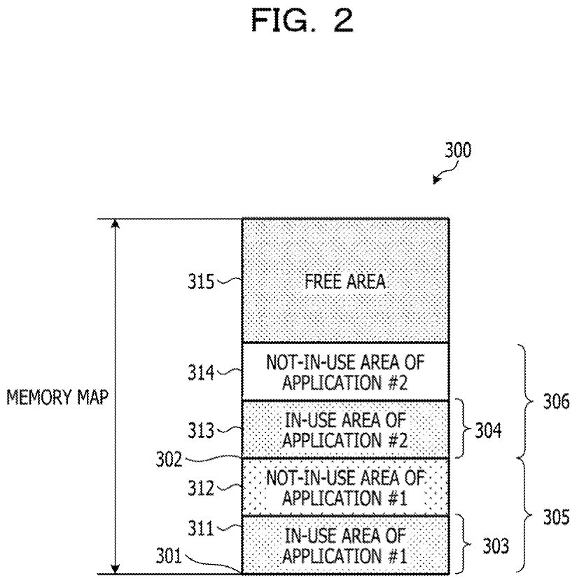

FIG. 2 describes calculation of the in-use GPU memory area. An example of calculation of the in-use GPU memory area performed by the in-use memory area prediction unit 123 will be described by using FIG. 2. FIG. 2 illustrates a use state in a memory map 300. A case will be described where applications #1 and #2 are already started as the applications 101.

The in-use memory area prediction unit 123 acquires a base address 301 for the application #1 and a base address 302 for the application #2. The in-use memory area prediction unit 123 determines a GPU memory usage 303 of the application #1 and a GPU memory usage 304 of the application #2. Based on the base addresses 301 and 302 and the GPU memory usages 303 and 304, the in-use memory area prediction unit 123 determines an in-use GPU memory area 311 of the application #1 and an in-use GPU memory area 313 of the application #2. Based on sizes 305 and 306 of the GPU memory areas allocated to the applications #1 and #2, respectively, the in-use memory area prediction unit 123 determines a not-in-use area 312 of the application #1 and a not-in-use area 314 of the application #2. In this case, the in-use memory area prediction unit 123 sets the remaining area as a free area 315.

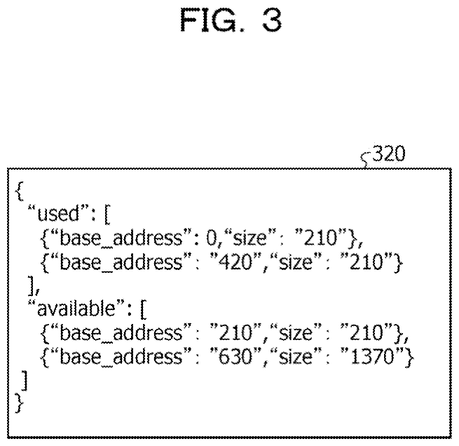

The in-use memory area prediction unit 123 creates a memory map indicating a GPU memory area allocatable to another process. FIG. 3 illustrates an example of a memory map indicating a GPU memory area allocatable to another process. FIG. 3 illustrates an example in which the total size of the GPU memory is 2 GB.

For example, if the current state is the state indicated by the memory map 300 illustrated in FIG. 2, the in-use memory area prediction unit 123 determines that an area having a base address of 0 and a size of 210 MB and corresponding to the in-use GPU memory area 311 is an in-use area, as indicated by a memory map 320 illustrated in FIG. 3. The in-use memory area prediction unit 123 also determines that an area having a base address of 420 and a size of 210 MB and corresponding to the in-use GPU memory area 313 is an in-use area. In contrast, the in-use memory area prediction unit 123 determines that an area having a base address of 210 and a size of 210 MB and corresponding to the not-in-use area 312 and an area having a base address of 630 and a size of 1370 MB and corresponding to the not-in-use area 314 and the free area 315 are available areas.

The in-use memory area prediction unit 123 outputs the updated memory map to the memory allocation unit 122.

The memory reservation unit 126 outputs, to the GPU driver 103, a request for reserving the entire GPU memory area available to the GPU 20. The memory reservation unit 126 acquires information on the entire GPU memory area from the GPU driver 103 and puts the entire GPU memory area under control. The memory reservation unit 126 notifies the in-use memory area prediction unit 123 of the base address and the size of the entire GPU memory.

The GPU driver 103 receives a request for reserving the entire area of the GPU memory from the memory reservation unit 126. The GPU driver 103 acquires, from the GPU 20, information on the entire GPU memory area of the GPU memory available to the GPU 20. The GPU driver 103 notifies the memory reservation unit 126 of the acquired information on the entire GPU memory area.

The GPU driver 103 receives, along with information on a GPU memory area to be used, an instruction for performing an inference process based on deep learning from each of the applications 101. The GPU driver 103 causes the GPU 20 to perform the inference process based on deep learning by using the designated GPU memory area. The GPU driver 103 acquires, from the GPU 20, a result of performing the inference process based on deep learning, and outputs the result to the application 101 that has instructed execution of the inference process based on deep learning.

The GPU 20 is a learning arithmetic processing apparatus that performs an inference process based on deep learning. In response to an instruction from the GPU driver 103, the GPU 20 performs the designated inference process based on deep learning by using a designated GPU memory area in the GPU memory held therein. The GPU 20 outputs, to the GPU driver 103, a result of performing the inference process based on deep learning.

Creation of a profile performed by the administrator terminal 2 will be described. The administrator terminal 2 includes the profile creation unit 200. In response to an instruction from an administrator, the profile creation unit 200 creates a profile denoting a change in a GPU memory usage of each of the applications 101. Details of a method for creating a profile denoting the change in the GPU memory usage of the application 101 with the elapse of time will be described below.

The profile creation unit 200 calculates the change in the GPU memory usage for each inference process algorithm (deep learning: DNN) used in the corresponding application 101. For example, the profile creation unit 200 calculates an intermediate output size for each layer based on parameters of deep learning. Description will be given by using nᵢ that denotes the number of channels in a layer i. A size of an image representing a feature quantity output from the layer i is denoted by a width×a height of the image. When wᵢ denotes the width and hᵢ denotes the height, the size is denoted by wᵢ×hᵢ. An input size of the layer i is denoted by wᵢ₋₁×hᵢ₋₁×nᵢ₋₁. For example, the input size of the layer i is equivalent to an output size of the layer i−1.

Parameters used in a convolution layer are (x, x) which denotes a kernel size, s which denotes a stride, and p which denotes padding. An output size of the convolution layer is denoted by Equation (1) below.

$${w}_{i} = ⌈ \frac{{w}_{i - 1} + 2 p - max ( 0 , x - s )}{s} ⌉ h = ⌈ \frac{{h}_{i - 1} + 2 p - max ( 0 , x - s )}{s} ⌉ {n}_{i} \qquad ( 1 )$$

A parameter used in a pooling layer is (x, x) which denotes the kernel size. An output size of the pooling layer is denoted by Equation (2) below.

$${w}_{i} = \frac{{w}_{i - 1}}{x} \\ {h}_{i} = \frac{{h}_{i - 1}}{x} \\ {n}_{i} \qquad ( 1 )$$

An output size of a rectified linear unit (ReLU) layer is denoted by Equation (3) below.

wᵢ=wᵢ₋₁

hᵢ=hᵢ₋₁

nᵢ (3)

An output size of a flat layer and a fully connected layer is denoted by Equation (4) below.

wᵢ=1

hᵢ=1

nᵢ (4)

A parameter used in a softmax layer is c which denotes the number of classes. In the softmax layer, as an exception, a value obtained by adding an inner product, an intermediate output denoting normalization, and an output size is used as an intermediate output size. In such a case, the intermediate output size is denoted by Lᵢ=2×c.

When the output size of the layer i is denoted by Lᵢ, Lᵢ=wᵢ×hᵢ×nᵢ holds. In the layer i, a GPU memory size equivalent to the sum of the input size from the layer i−1 and the output size of the layer i is used. Therefore, when the GPU memory usage of the layer i is denoted by Fᵢ, the GPU memory usage is denoted as Fᵢ=Lᵢ₋₁+Lᵢ.

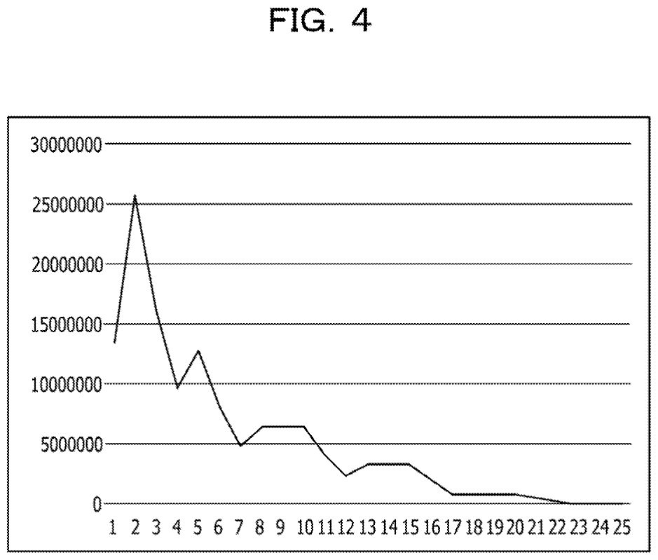

In the above manner, the profile creation unit 200 calculates the GPU memory usage of each layer. FIG. 4 is a diagram illustrating an example of a change in a GPU memory usage of each layer. In FIG. 4, the vertical axis denotes the GPU memory usage Fᵢ and the horizontal axis denotes the layer i of deep learning. Since the layer i indicates the processing order, the layer i corresponds to an execution time that is an elapsed time in execution. The GPU memory usage of each layer is calculated. However, the value of the change changes for each layer as illustrated in FIG. 4. Therefore, if this value is used in prediction of the GPU memory usage as it is, the calculation becomes complicated and the processing load increases. Accordingly, in the present embodiment, the profile creation unit 200 models the change in the GPU memory usage in order to reduce the overhead of memory management. However, if the overhead is permissible to some extent, the profile may be created by using the change in the GPU memory usage of each layer.

The profile creation unit 200 divides the calculated change in the GPU memory usage of each layer of deep learning into blocks. For example, in the present embodiment, the profile creation unit 200 divides the change in the GPU memory usage into three blocks, such as a block where the GPU memory usage is at a peak, a block where the GPU memory usage is at ½ of the peak, and a block where the GPU memory usage is at ¼ of the peak. The division of the change in the GPU memory usage is not limited to this division method. The sizes of the blocks and the number of blocks may be set in accordance with the operation.

The profile creation unit 200 uses a ratio between the numbers of layers included in the respective blocks as a ratio between the execution times. In this manner, modeling of the change in the GPU memory usage in deep learning is completed. An example of a modeling algorithm will be described below.

The profile creation unit 200 acquires the total number of layers of deep learning. It is assumed that the total number of layers is denoted by k. For each layer i, the profile creation unit 200 determines a maximum value Mᵢ of Fⱼ in a layer j subsequent to the layer i. For example, Mᵢ is denoted by Equation (5) below. M₁ denotes the peak of the GPU memory usage in target deep learning.

$${M}_{i} = {max}_{i \leq j \leq k} {F}_{j} \qquad ( 5 )$$

The profile creation unit 200 then determines the first x that satisfies Mₓ≤Mᵢ/2, where x is denoted by Equation (6) below. The layer x is a starting layer of a second block along the elapse of the execution time. The horizontal width of a first block is denoted by (x−1)/k.

$$x = {min}_{1 \leq i \leq k} i , \\ where {M}_{i} \leq {M}_{1} / 2 \qquad ( 6 )$$

The profile creation unit 200 then determines a first y that satisfies M_{y}≤M₁/4, where y is denoted by Equation (7) below. The layer y is a starting layer of a third block along the elapse of the execution time. The horizontal width of the second block is denoted by (y−x)/k. The horizontal width of the third block is denoted by (k−y+1)/k.

$$y = {min}_{1 \leq i \leq k} i , \\ where {M}_{i} \leq {M}_{1} / 4 \qquad ( 7 )$$

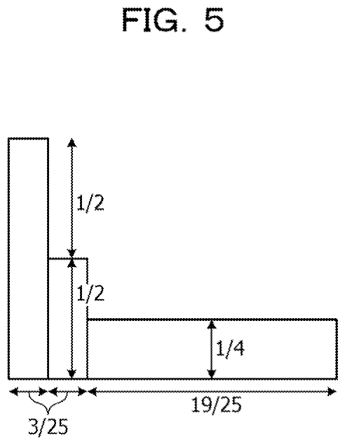

FIG. 5 illustrates an example of the modeled GPU memory usage. FIG. 5 illustrates an example in which the GPU memory usage illustrated in FIG. 4 is modeled. The block where the GPU memory usage is at the peak has a horizontal width of 3/25 of the entire execution time. The block where the GPU memory usage is at ½ of the peak has a horizontal width of 3/25 of the entire execution time. The block where the GPU memory usage is at ¼ of the peak has a horizontal width of 19/25 of the entire execution time.

In the present embodiment, the ratio between the numbers of layers is used as the ratio between the execution times. However, the index for modeling is not limited to this. As an example, the ratio between the execution times is not a simple ratio between the numbers of layers, and the ratio may be calculated by changing the weight for the execution time of the layer in accordance with the type of the layer. For example, the ratio between the execution times may be calculated on the assumption that the convolution layer takes 1.5 times longer than the other layers. To reduce the overhead of division in calculation of the ratio between the execution times, the division may be implemented through a bit shift operation by approximating a denominator to a value larger than the actual value of the denominator so that the denominator becomes an exponent of 2.

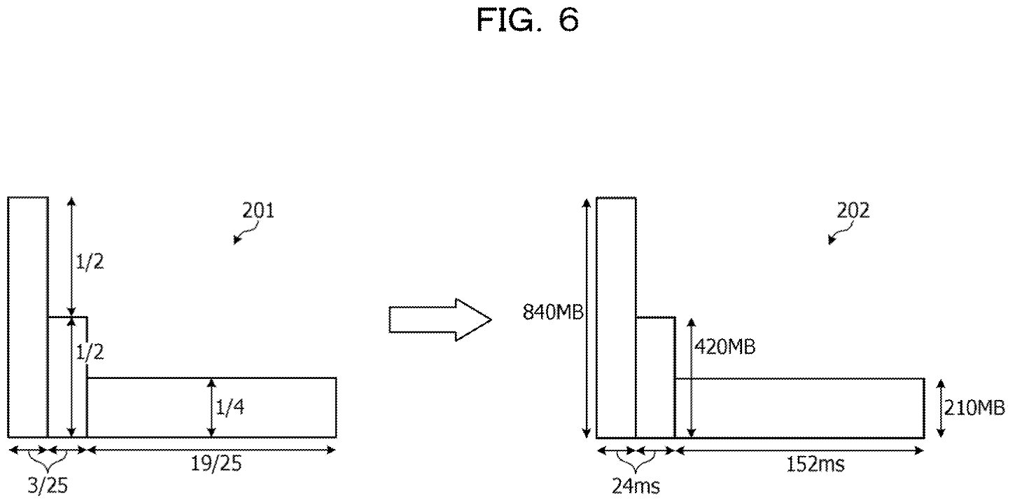

The profile creation unit 200 then profiles the change in the modeled GPU memory usage. For example, the profile creation unit 200 calculates the change in the actual GPU memory usage from the model, the actual peak, and the total execution time. FIG. 6 describes profiling of the change in the GPU memory usage. FIG. 6 illustrates a case of profiling a model 201 denoting the change in the modeled GPU memory usage.

The profile creation unit 200 acquires 840 MB as the peak value of the change in the GPU memory usage, and acquires 200 ms as the total execution time. The profile creation unit 200 allocates 840 MB which is the peak value and 200 ms which is the total execution time to the model 201. In this manner, the profile creation unit 200 determines a graph 202 denoting the change in the actual GPU memory usage according to the model 201. The profile creation unit 200 creates a profile denoting the change in the GPU memory usage from the graph 202.

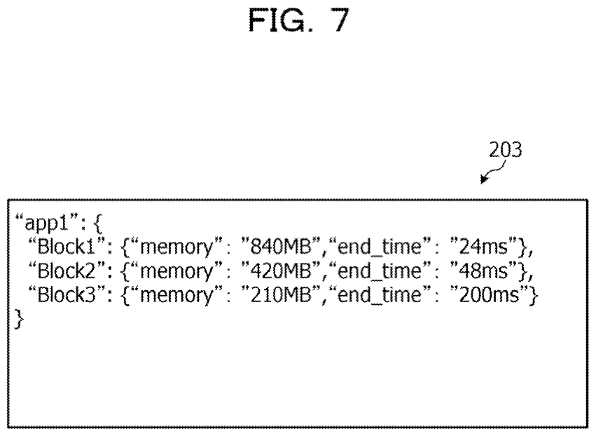

FIG. 7 illustrates an example of the profile denoting the change in the GPU memory usage. A profile 203 illustrated in FIG. 7 indicates that the GPU memory usage is 840 MB when the elapsed time from the start of deep learning is from 0 ms to 24 ms, is 420 MB when the elapsed time is from 24 ms to 48 ms, and is 210 MB when the elapsed time is from 48 ms to 200 ms. The profile 203 indicates that processing is completed in 200 ms and that the GPU memory usage becomes 0 thereafter.

In the present embodiment, the description has been given of the configuration in which the administrator terminal 2 includes the profile creation unit 200 that creates a profile and the server 1 acquires the profile created by the administrator terminal 2. However, the configuration is not limited this. For example, the server 1 may include the profile creation unit 200 and may perform memory allocation control described below by using a profile created thereby.

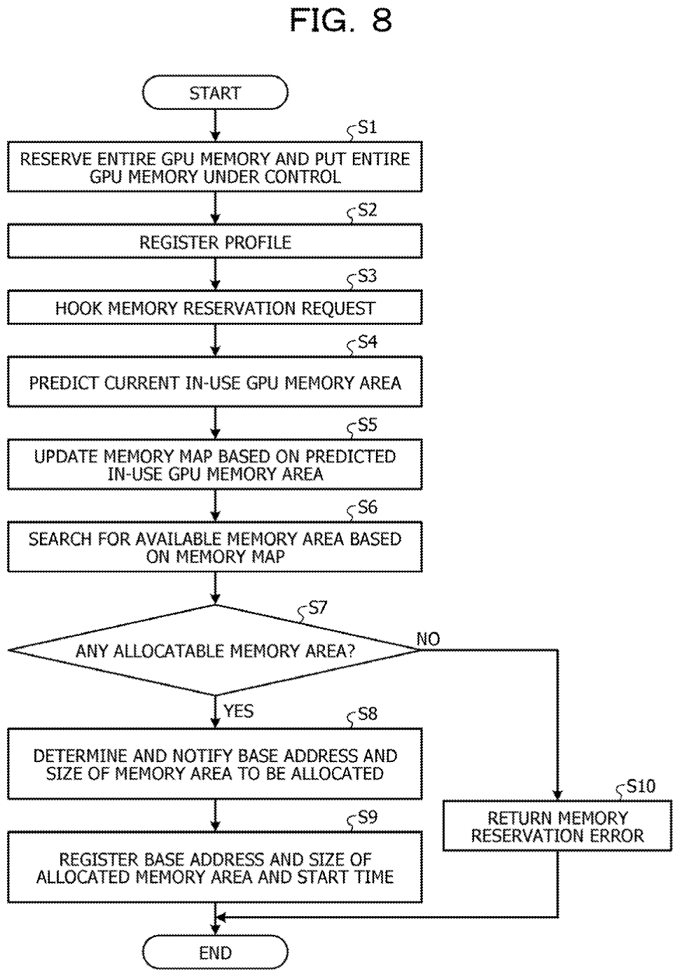

FIG. 8 is a flowchart of memory allocation control for a deep learning process according to a first embodiment. A flow of memory allocation control for a deep learning process according to the present embodiment will be described with reference to FIG. 8.

The memory reservation unit 126 outputs, to the GPU driver 103, a request for reserving the entire GPU memory area available to the GPU 20. The memory reservation unit 126 acquires information on the entire GPU memory area from the GPU driver 103 and puts the entire GPU memory area under control (step S1). The memory reservation unit 126 notifies the in-use memory area prediction unit 123 of the base address and the size of the entire GPU memory.

The profile DB 125 receives registration of a profile denoting the change in the GPU memory usage of each of the applications 101 from the profile creation unit 200 of the administrator terminal 2 (step S2).

The request hooking unit 121 hooks and captures a memory reservation request issued by the application 101 (step S3).

The memory allocation unit 122 receives, from the request hooking unit 121, input of the memory reservation request of the newly started application 101. The memory allocation unit 122 outputs a memory map update request to the in-use memory area prediction unit 123. The in-use memory area prediction unit 123 receives input of the memory map update request from the memory allocation unit 122. The in-use memory area prediction unit 123 acquires the start history of the started application 101 from the start history DB 124. The in-use memory area prediction unit 123 also acquires the profile denoting the change in the GPU memory usage of the started application 101. By using the start history of the started application 101 and the profile denoting the change in the GPU memory usage of the started application 101, the in-use memory area prediction unit 123 predicts the current in-use GPU memory area of the started application 101 (step S4).

Based on the predicted in-use GPU memory area, the in-use memory area prediction unit 123 updates the memory map (step S5). The in-use memory area prediction unit 123 outputs the updated memory map to the memory allocation unit 122.

The memory allocation unit 122 acquires input of the updated memory map from the in-use memory area prediction unit 123. Based on the updated memory map, the memory allocation unit 122 searches for an available memory area for the application 101 that has made the memory reservation request (step S6).

The memory allocation unit 122 determines, based on the search result, whether there is an allocatable memory area (step S7).

When there is an allocatable memory area (Yes in step S7), the memory allocation unit 122 determines a base address and a size of a memory area to be allocated. The memory allocation unit 122 notifies, via the request hooking unit 121, the application 101 that has made the memory reservation request of the determined base address and size (step S8).

The memory allocation unit 122 registers the base address and the size of the allocated memory area and the start time to the start history DB 124 in association with each started application 101 (step S9).

On the other hand, if there is no allocatable memory area (No in step S7), the memory allocation unit 122 notifies, via the request hooking unit 121, the application 101 that has made the memory reservation request of a memory reservation error (step S10). The memory allocation control performed when the application 101 is newly started is then completed.

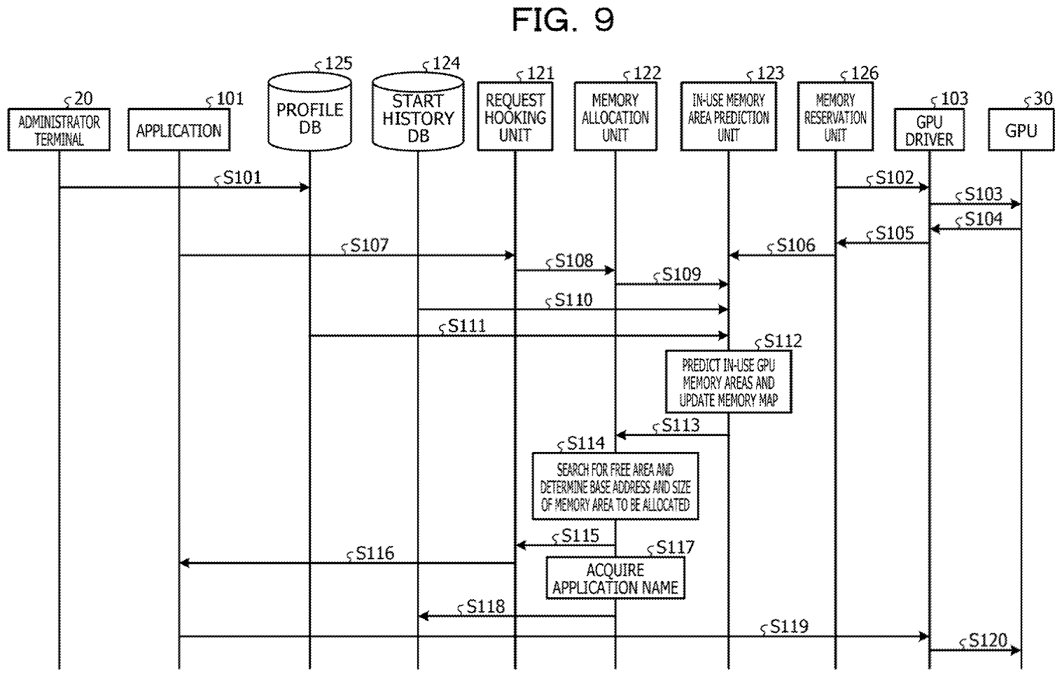

FIG. 9 is a sequence diagram of the memory allocation control for a deep learning process according to the first embodiment. With reference to FIG. 9, an overall flow of the memory allocation control for a deep learning process according to the present embodiment will be described again.

By using the administrator terminal 2, an administrator registers a profile denoting a change in a GPU memory usage of each of the applications 101 to the profile DB 125 of the server 1 (step S101).

The memory reservation unit 126 transmits a request for reserving the entire GPU memory area to the GPU driver 103 (step S102).

The GPU driver 103 transmits, to the GPU 20, a request for acquiring information on the memory area held (step S103).

The GPU 20 returns the information on the memory area held therein to the GPU driver 103 (step S104).

The GPU driver 103 acquires the information on the memory area held in the GPU 20, and outputs the information on the entire GPU memory area to the memory reservation unit 126 (step S105).

The memory reservation unit 126 acquires the information on the entire GPU memory area and puts the entire GPU memory area under control. The memory reservation unit 126 notifies the in-use memory area prediction unit 123 of a base address and a size of the reserved GPU memory area (step S106).

The request hooking unit 121 hooks and takes in a memory reservation request issued from the newly started application 101 (step S107).

The request hooking unit 121 outputs the memory reservation request of the newly started application 101 to the memory allocation unit 122 (step S108).

The memory allocation unit 122 outputs a memory map update request to the in-use memory area prediction unit 123 (step S109).

In response to receiving the memory map update request from the memory allocation unit 122, the in-use memory area prediction unit 123 acquires, from the profile DB 125, a profile denoting the change in the GPU memory usage of each of the already started applications 101 (step S111).

The in-use memory area prediction unit 123 also acquires the start history of each of the started applications 101 from the start history DB 124 (step S110).

By using the start histories and the profiles of the started applications 101, the in-use memory area prediction unit 123 predicts the in-use GPU memory areas. The in-use memory area prediction unit 123 newly creates a memory map by using the prediction result of the in-use GPU memory areas of the started applications 101 and updates the memory map (step S112).

The in-use memory area prediction unit 123 outputs the updated memory map to the memory allocation unit 122 (step S113).

The memory allocation unit 122 performs a free area search by using the updated memory map. The memory allocation unit 122 determines a base address and a size of a GPU memory area to be allocated to the newly started application 101 (step S114).

The memory allocation unit 122 notifies the request hooking unit 121 of the base address and the size of the GPU memory area allocated to the newly started application 101 (step S115).

The request hooking unit 121 notifies the newly started application 101 of the base address and the size of the GPU memory area allocated by the memory allocation unit 122 (step S116).

The memory allocation unit 122 acquires a name of the newly started application 101 by using a process ID of a process executed by the application 101 (step S117).

The memory allocation unit 122 registers the start time of the application 101 and the base address and the size of the GPU memory area allocated to the application 101 to the start history DB 124 in association with the name of the application 101 (step S118).

The application 101 acquires information on the base address and the size of the allocated GPU memory area from the request hooking unit 121. The application 101 instructs the GPU driver 103 to perform deep learning by using the allocated GPU memory area (step S119).

The GPU driver 103 controls the GPU 20 so that the GPU 20 performs the inference process based on deep learning by using the designated GPU memory area (step S120).

As described above, by using the change in modeled the GPU memory usage with the elapse of time when each of the applications 101 performs deep learning, the GPU memory management unit 102 according to the present embodiment predicts the GPU memory usage of each of the applications 101 at that time. The GPU memory management unit 102 determines in-use GPU memory areas by using the prediction result of the GPU memory usages, and creates a memory map indicating a GPU memory area allocatable at that time. The GPU memory management unit 102 allocates a GPU memory area to the newly started application 101, by using the memory map indicating the GPU memory area allocatable at that time. Thus, a GPU memory area not in use by the started applications 101 may be newly allocated to another application. Consequently, the use efficiency of the GPU memory area may be improved. By improving the use efficiency of the GPU memory area, the processing efficiency of the inference processes based on deep learning may be improved.

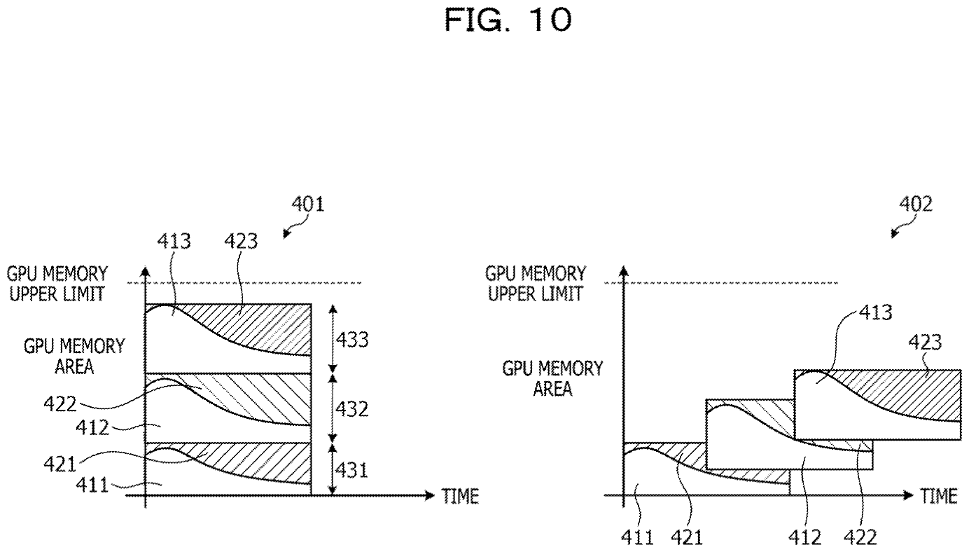

FIG. 10 illustrates a comparison between a memory usage in a case where GPU memory area division is performed according to peaks and a memory usage in a case where memory allocation according to the first embodiment is performed. A graph 401 illustrated in FIG. 10 denotes the change in the GPU memory usage in a case where the GPU memory area division is performed according to peaks. A graph 402 denotes the change in the memory usage when the memory allocation according to the first embodiment is performed. A case will be described where applications #1 to #3 are sequentially caused to operate as the applications 101 that perform inference processes. In both the graphs 401 and 402, the vertical axis denotes the GPU memory area and the horizontal axis denotes the elapsed time.

In-use areas 411 to 413 denote in-use memory areas of the applications #1 to #3, respectively. Not-in-use areas 421 to 423 denote areas that are not in use in the memory areas allocated to the applications #1 to #3, respectively.

When the GPU memory area division is performed in accordance with the peaks, as indicated by the graph 401, a GPU memory area having a size equivalent to the sum of peak usages 431 to 433 of the respective applications #1 to #3 is allocated. Thus, the remaining free area is small. In this case, the not-in-use areas 421 to 423 are areas that are not in use but are not allocatable to another application 101.

In contrast, when the memory allocation control according to the present embodiment is performed, as indicated by the graph 402, the not-in-use area 421 is also treated as a free area. Thus, the GPU memory area is allocated to the application #2 from the GPU memory area including the not-in-use area 421. The not-in-use area 422 is similarly treated as a free area, and the GPU memory area is allocated to the application #3 from the GPU memory area including the not-in-use area 422. Thus, in a case where the memory allocation control according to the present embodiment is performed, the use efficiency of the GPU memory when inference processes based on deep learning are performed in parallel may be improved as compared with a case where the GPU memory area division is performed in accordance with the peaks.

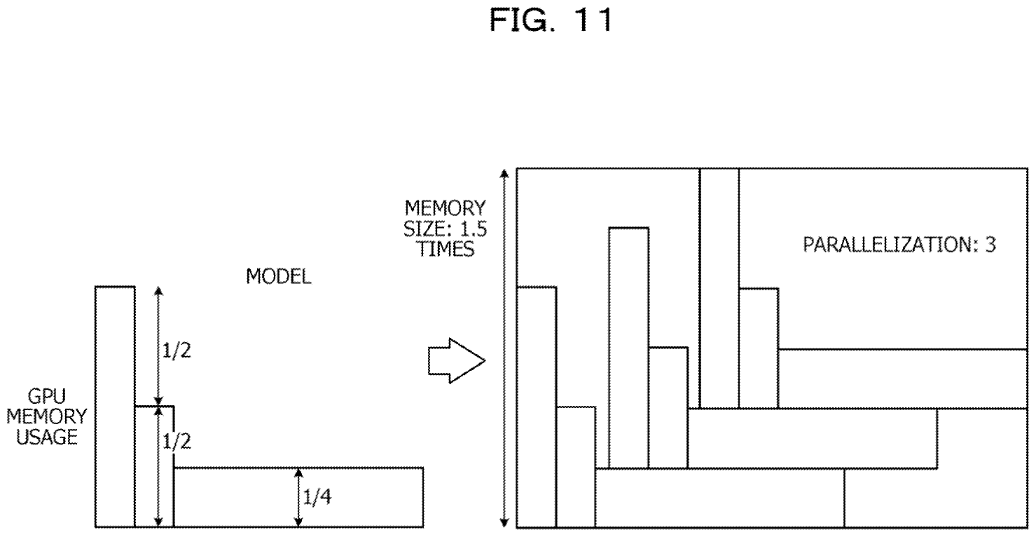

For example, in a case of the memory allocation control according to the present embodiment, by utilizing the not-in-use GPU memory area, twice as many inference processes as those performed in a case where the GPU memory area division is performed in accordance with the peaks may be performed in parallel. FIG. 11 describes parallelization of applications by using the change in the modeled GPU memory usage. For example, in a case of the present embodiment, a ratio between a size of the GPU memory and the number of inference processes performed in parallel is 1:2. For example, as illustrated in FIG. 11, when it is assumed that the change in the GPU memory usage is the same for all the applications, three inference processes may be performed in parallel by reserving a GPU memory area that is 1.5 times the GPU memory usage of a single application. The number of applications to be parallelized may be further increased by using a block smaller than the block in which the GPU memory usage is at ¼ of the peak when modeling is performed.

(Hardware Configuration)

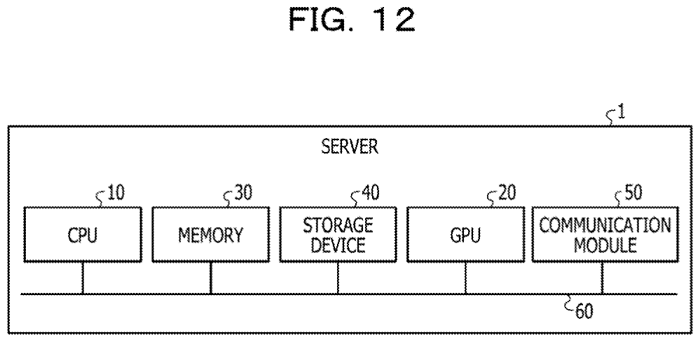

FIG. 12 is a hardware configuration diagram of the server. The server 1 according to the present embodiment has a hardware configuration as illustrated in FIG. 12, for example. The server 1 includes a memory 30, a storage device 40, and a communication module 50 in addition to the CPU 10 and the GPU 20. The CPU 10, the GPU 20, the memory 30, the storage device 40, and the communication module 50 are coupled to each other by a bus 60.

The storage device 40 is an auxiliary storage device such as a solid-state drive (SSD) or a hard disk. The storage device 40 stores various programs including programs for causing the applications 101, the GPU memory management unit 102, and the GPU driver 103 illustrated in FIG. 1 to operate. The storage device 40 may store the start history DB 124, the profile DB 125, and so on.

The communication module 50 is a network interface that allows the server 1 to communicate with an external device. For example, the CPU 10 communicates with the administrator terminal 2 via the communication module 50.

The memory 30 is a main storage device such as a synchronous dynamic random-access memory (SDRAM).

The CPU 10 implements functions of the applications 101, the GPU memory management unit 102, and the GPU driver 103 illustrated in FIG. 1 by reading out the various programs stored in the storage device 40 and loading and executing the programs on the memory 30.

### Second Embodiment

A second embodiment will be described. The server 1 according to the present embodiment is also illustrated in the block diagram of FIG. 1. The server 1 according to the present embodiment is different from that of the first embodiment in that, when a free area large enough for a requested size is not found, the server 1 stands by and reserves a GPU memory after the free area increases. In description below, description of substantially the same operations of the individual units as those described in the first embodiment will be omitted.

In response to receiving a GPU-memory-area reservation request, the memory allocation unit 122 acquires an updated memory map from the in-use memory area prediction unit 123 and determines whether a GPU memory area may be reserved in response to the GPU-memory-area reservation request. At this time, if the free area of the GPU memory is smaller than the requested size, the memory allocation unit 122 performs a process below.

The memory allocation unit 122 acquires a start history of each started application 101 from the start history DB 124. The memory allocation unit 122 also acquires, from the profile DB 125, a profile denoting a change in a GPU memory usage of each started application 101. The memory allocation unit 122 calculates a time at which the in-use GPU memory area of each started application 101 changes, by using the profile and the start time of the started application 101. For example, the memory allocation unit 122 determines the time at which the in-use GPU memory area changes, by adding the elapsed time of the profile to the start time of each application 101. The memory allocation unit 122 may use end_time of the profile 203 illustrated in FIG. 7 as the elapsed time of the profile.

The memory allocation unit 122 requests the in-use memory area prediction unit 123 to create a memory map at each time at which the in-use GPU memory area changes. The memory allocation unit 122 acquires, from the in-use memory area prediction unit 123, the memory map at each time at which the in-use GPU memory area changes. By using each acquired memory map, the memory allocation unit 122 identifies times at which there is a free area from which an area of the requested size is allocatable. The memory allocation unit 122 determines, as an allocation time, the closest time among the identified times.

The memory allocation unit 122 stands by up until the determined allocation time. When the allocation time comes, the memory allocation unit 122 determines, by using the memory map for that time, the base address and the size of the GPU memory area to be allocated to the application 101 that has requested reservation of the GPU memory area. The memory allocation unit 122 notifies the application 101 of the determined base address and size of the GPU memory area to be allocated. The memory allocation unit 122 registers, to the start history DB 124, the start time of the application and the base address and the size of the GPU memory area to be allocated. The time at which the base address and the size of the GPU memory area to be allocated are notified is treated as the start time of the application.

As described above, when the GPU memory management unit according to the present embodiment hooks a GPU memory reservation request, in a case where a free area large enough for the requested size is not found, the GPU memory management unit estimates, from the profile and the start history, the time up until an area of the requested size becomes available. The GPU memory management unit stands by up until the estimated time and then reserves the GPU memory. Consequently, the application may be started as soon as possible, and the processing efficiency of deep learning may be improved by improving the use efficiency of the GPU memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a learning arithmetic processing circuit configured to perform each of a plurality of inference processes based on deep learning by using a memory area allocated to the inference process; and
a processor configured to perform processing, the processing including:
predicting an in-use memory area of each of the inference processes, based on a profile denoting a change in a memory usage while the inference process is performed by the learning arithmetic processing circuit according to an algorithm of the inference process and based on a start history of the inference process, and
creating a memory map, based on the predicted in-use memory area; and
allocating the memory area to the inference process, based on the memory map to cause the learning arithmetic processing circuit to perform each of the inference processes.

2. The information processing apparatus according to claim 1, wherein
the profile indicates information modeled by classifying layers included in the deep learning into a plurality of blocks by approximating the change in the memory usage of each of the layers.

3. The information processing apparatus according to claim 1,
wherein the processing further includes:
reserving an entire memory area available to the learning arithmetic processing circuit;
putting the entire memory area under control; and
allocating the memory area from the reserved entire memory area.

4. The information processing apparatus according to claim 1, wherein
the start history of the inference process includes a start time of the inference process and information indicating the memory area allocated to the inference process.

5. The information processing apparatus according to claim 1,
wherein the processing further includes:
detecting a memory reservation request for the inference process,
in response to the memory reservation request, performing the predicting of the in-use memory area and the creating of the memory map.

6. The information processing apparatus according to claim 5, wherein
the detecting of the memory reservation request takes in the memory reservation request for an inference process to be newly performed,
the predicting of the in-use memory area predicts the in-use memory area of a started inference process and creates the memory map, and
the allocating of the memory area allocates the memory area to the inference process to be newly performed.

7. The information processing apparatus according to claim 1, wherein
the allocating of the memory area searches for the memory area to be allocated, based on a not-in-use memory area indicated by the memory map and a memory size to be reserved, and determines the memory area to be allocated to the inference process.

8. The information processing apparatus according to claim 1, wherein
the allocating of the memory area registers, to a start history database, along with a start time of each of the inference processes, a base address and a size of the memory area allocated to the inference process, and
the predicting of the in-use memory area acquires the start history of each of the inference processes from the start history database.

9. The information processing apparatus according to claim 1,
the processing further including:
calculating, for each algorithm of the inference process, the change in the memory usage of each of the layers included in the deep learning,
classifying the layers into a plurality of blocks by approximating the change in the memory usage,
determining a ratio between execution times of the respective blocks, and
creating a profile denoting the change in the memory usage for each elapsed time from a start time, based on the ratio between the execution times of the respective blocks.

10. The information processing apparatus according to claim 1, wherein
in a case where a free memory area is insufficient for the memory area to be allocated, the allocating of the memory area predicts, based on the profile and the start history, a time at which the memory area to be allocated is to be reserved, stands by up until the predicted time, and allocates the memory area.

11. An information processing method for controlling a learning arithmetic processing apparatus configured to perform each of a plurality of inference processes based on deep learning by using a memory area allocated to the inference process, the information processing method comprising:
predicting an in-use memory area of each of the inference processes, based on a profile denoting a change in a memory usage while the inference process is performed by the learning arithmetic processing apparatus according to an algorithm of the inference process and based on a start history of the inference process;
creating a memory map, based on the predicted in-use memory area; and
allocating the memory area to each of the inference processes, based on the created memory map, and causing the learning arithmetic processing apparatus to perform each of the inference processes.

12. A non-transitory computer-readable storage medium storing an information processing program for controlling a learning arithmetic processing apparatus configured to perform each of a plurality of inference processes based on deep learning by using a memory area allocated to the inference process, the information processing program causing the learning arithmetic processing apparatus to perform processing, the processing comprising:
predicting an in-use memory area of each of the inference processes, based on a profile denoting a change in a memory usage while the inference process is performed by the learning arithmetic processing apparatus according to an algorithm of the inference process and based on a start history of the inference process;
creating a memory map, based on the predicted in-use memory area; and
allocating the memory area to each of the inference processes, based on the created memory map, and causing the learning arithmetic processing apparatus to perform each of the inference processes.
